(19) United States
(12) Patent Application Publication
(10) Pub. No.: US 2026/0044483 A1
(43) Pub. Date: Feb. 12, 2026

(54) INFORMATION PROCESSING DEVICE, INFORMATION PROCESSING METHOD, AND NON-TRANSITORY COMPUTER READABLE MEDIUM

(71) Applicant: Preferred Networks, Inc., Tokyo (JP)

(72) Inventors: Akifumi IMANISHI, Tokyo (JP); Zijian XU, Tokyo (JP); Sixue WANG, Tokyo (JP)

(73) Assignee: Preferred Networks, Inc., Tokyo (JP)

(21) Appl. No.: 19/363,857

(22) Filed: Oct. 21, 2025

Related U.S. Application Data
(63) Continuation of application No. PCT/JP2024/016415, filed on Apr. 26, 2024.

(30) Foreign Application Priority Data
Apr. 28, 2023 (JP) 2023-074667

(51) Int. Cl. G06F 16/22; G06F 16/23

(52) U.S. Cl. CPC G06F 16/2246; G06F 16/2379

(57) ABSTRACT

A device includes a memory and a processor. The processor is configured to acquire a first structure including information on an execution order of instructions and information on an amount of memory required for execution of each instruction, generate a second structure in which the information on the execution order and the information on the amount of memory are updated, by executing a manipulation on the first structure, acquire an evaluation value based on the second structure, and update the first structure using the second structure where the evaluation value satisfies a first condition. The first structure and the second structure are structures in which change and value calculation for a predetermined interval are supported, and the processor repeats the generation of the second structure, the acquisition of the evaluation value, and the update of the first structure when the evaluation value satisfies the first condition.

### CROSS REFERENCE TO THE RELATED APPLICATION

This application is continuation application of International Application No. JP2024/016415, filed on Apr. 26, 2024, which claims priority to Japanese Application No. 2023-074667, filed on Apr. 28, 2023, the entire contents of which are incorporated herein by reference.

### FIELD

This disclosure relates to an information processing device, an information processing method, a program, an intermediate language generation method, a machine language generation method, and a data structure generation method.

### BACKGROUND

In recent years, advances in computing technology have led to an increase in information processing handling a large amount of data, and the lack of capacity of a storage device of a computer has become a problem. This may be addressed by improving a program to be faster with reduced memory, but the improvement requires specialized knowledge and the improvement of the large-scale program is often beyond human control. Therefore, for a program of a certain scale or larger, the computer sometimes automatically improves the program. On the other hand, it is still a big problem to automatically generate a faster program with less memory while satisfying conditions for ensuring the transparency of the program.

### BRIEF DESCRIPTION OF DRAWINGS

FIG. 1 is a block diagram schematically illustrating an example of an information processing device according to an embodiment.

FIG. 2 is a flowchart illustrating an example of processing by the information processing device according to an embodiment.

FIG. 3 is a chart illustrating an example of describing processes according to an embodiment in a graph.

FIG. 4 is a chart illustrating an example of a time-series variation in amount of memory used according to an embodiment.

FIG. 5 to FIG. 7 are flowcharts illustrating examples of manipulations of processes according to an embodiment.

FIG. 8 is a chart illustrating an example of the time-series variation in amount of memory used according to an embodiment.

FIG. 9 is a chart illustrating an example of describing processes according to an embodiment in a graph.

FIG. 10 is a flowchart illustrating an example of the manipulations of the processes according to an embodiment.

FIG. 11 and FIG. 12 are charts each illustrating an example of the time-series variation in amount of memory used according to an embodiment.

FIG. 13 is a flowchart illustrating an example of the manipulations of the processes according to an embodiment.

FIG. 14 and FIG. 15 are charts illustrating an example of the time-series variation in amount of memory used according to an embodiment.

FIG. 16 is a flowchart illustrating an example of update of a tree according to an embodiment.

FIG. 17 is a block diagram schematically illustrating an example of implementation of an information processing device according to an embodiment.

### DETAILED DESCRIPTION OF THE INVENTION

An information processing device includes at least one memory and at least one processor. The at least one processor is configured to acquire a first data structure including information on an execution order of a plurality of instructions and information on an amount of memory required for execution of each instruction, generate a second data structure in which the information on the execution order and the information on the amount of memory are updated, by executing a predetermined manipulation on the first data structure acquire an evaluation value based on the second data structure, and update the first data structure using the second data structure in a case where the evaluation value satisfies a first condition. The first data structure and the second data structure are data structures in which change and value calculation for a predetermined interval are supported. The at least one processor executes, a plurality of times, a generation process of the second data structure, an acquisition process of the evaluation value, and an update process of the first data structure when the evaluation value satisfies the first condition.

A problem to be solved by embodiments of this disclosure may be optimization relating to at least either a memory area size or processing time required for a series of processes, and can also be a problem corresponding to effects described in the embodiments as some non-limiting examples of the problem. In other words, the problem corresponding to at least arbitrary one of the effects described in the explanation of the embodiments in this disclosure can be the problem to be solved in this disclosure.

Hereinafter, embodiments of the present invention will be explained with reference to the drawings. The drawings and the description of the embodiments are indicated as examples and are not intended to limit the present invention.

In an information processing device in this disclosure, for example, a processor capable of at least one pipeline process executes swap of the order of processes included in a series of processes or addition and deletion of partially or fully overlapping processes to optimize the storage situation and the like of variables. As a result of this, the information processing device can reduce the memory usage or speed up the processes without decreasing the operation accuracy.

The processor which executes the optimized processes may be able to perform pipeline processes in parallel, and may process data in any format of Single Instruction, Multiple Data stream (SIMD), Multiple Instruction, Multiple Data stream (MIMD), Single Instruction, Single Data stream (SISD), Multiple Instruction, and Single Data stream (MISD). Further, the processor which executes the optimized processes may be implemented with a superscalar architecture.

In this disclosure, an information processing device including a processor for executing an optimized program and an information processing device including a processor for optimizing a program are described, and it should be noted that, in the case of simply describing an information processing device or a processor, they can be read appropriately according to the context. The information processing device for executing optimization can also execute the optimization based on an architecture of the information processing device for executing the optimized program as an example.

Further, it is not eliminated that the information processing device for executing the optimized program and the information processing device for optimizing the program are the same information processing device. In other words, the information processing device can also optimize by itself the program relating to a series of processes executed by itself.

The processor may be, for example, a multi-core Central Processing Unit (CPU) or Graphics Processing Unit (GPU). For processors having different functions, the information processing device can perform optimization based on the processing capability or the configuration of the architecture in each of the processors. For example, the information processing device can perform different optimizations suitable for the processors for the same series of processes in different processors.

The information processing device executes optimization of the program corresponding to a target device, for example, for a source describing a program or an intermediate expression for the source. The information processing device converts, for example, the series of processes expressed by the intermediate expression into an optimized series of processes expressed by the intermediate expression.

In the case where the optimized program is expressed by the intermediate expression, the information processing device executing the optimized series of processes may execute the series of processes by using a Just in Time (JIT) compiler for the intermediate expression, or execute the series of processes by converting the intermediate expression into an executable format in advance.

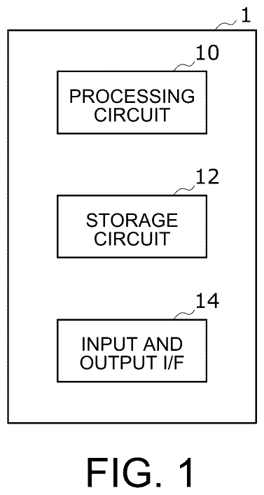

FIG. 1 is a block diagram schematically illustrating an example of an information processing device according to an embodiment.

An information processing device 1 includes a processing circuit 10, a storage circuit 12, and an input and output interface (hereinafter, described as an input and output I/F 14). The information processing device 1 executes optimization relating to at least one of memory and processing time for a series of processes 10 including a plurality of instructions. The information processing device 1 includes components such as a control unit for controlling each component, a power supply for supplying power to each component, and so on which are required to drive the information processing device 1 as appropriate, in addition to the components illustrated in FIG. 1.

The processing circuit 10 is a circuit which mainly executes an operation process in the information processing device 1. The processing circuit 10 may include, for example, a processor such as a CPU, a GPU, or the like. The processing circuit 10 may execute the operation process in cooperation with at least one other processing circuit provided outside the information processing device 1.

The storage circuit 12 may include a memory, a storage, or the like which can store data required for processes in the information processing device 1, data required to be stored during a process, a program required for software, or the like. The storage circuit 12 does not need to be entirely provided inside the information processing device 1, and at least part thereof may be provided outside the information processing device 1, as with the processing circuit 10.

The input and output I/F 14 has an interface which connects the inside and the outside of the information processing device 1. The input and output I/F 14 can include, for example, an interface of an arbitrary standard for transmitting and receiving data, a user interface for a user to input or a user interface for the user to output, or an interface for transmitting and receiving data to/from the user interfaces.

When at least one of the processing circuit 10 and the storage circuit 12 operates in cooperation with the component outside the information processing device 1, the information processing device 1 can transmit and receive data via the input and output I/F 14.

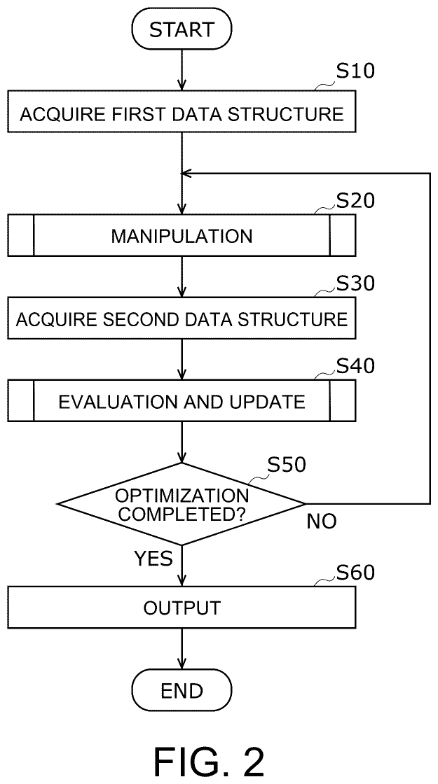

Next, the processing by the information processing device 1 in this disclosure will be explained. FIG. 2 is a flowchart illustrating an example of the processing by the information processing device 1 according to an embodiment.

The processing circuit 10 acquires a data structure (first data structure) including a description relating to an amount of memory used at each timing in a series of processes being a target of optimization (S10). The data structure includes information on the series of processes having a plurality of instructions (for example, information on an execution order of instructions), and information on the amount of memory used.

The information on the amount of memory used may include information on the amount of memory required for each instruction, and may further include information on a total amount of memory required at every timing when executing the instruction.

This data structure may be represented by a tree. In the following non-limiting example, the data structure will be explained using a tree representation, which will not eliminate other expressions of the data structure.

The processing circuit 10 computes a first amount of memory which represents the amount of memory required for storing an input/output variable in an instruction written in an arbitrary format. Further, the processing circuit 10 can also reflect, on the first amount of memory, an amount of memory relating to an intermediate variable or the like required for the operation in each instruction or an amount of memory relating to an input/output variable, an intermediate variable, or the like required in another instruction or the like during execution of an instruction.

For example, the first amount of memory is an amount of memory required for execution of each instruction in the series of processes including the plurality of instructions. Besides, the first amount of memory may be, for example, an amount of memory required at timing when executing each instruction in the series of processes including the plurality of instructions. In other words, when the plurality of instructions are being executed in parallel, the first amount of memory is not the amounts of memory in individual instructions executed in parallel but may be the sum of the amounts of memory required in the plurality of instructions executed in parallel.

The processing circuit 10 generates a first tree as a set of time-series intervals, from the first amount of memory acquired. As a non-limiting example of the first data structure, the processing circuit 10 divides the time series into each interval in which each operation (instruction) is to be executed, and acquires the first tree with this interval regarded as a node of a leaf. The interval is a phrase indicating a part of the time series of the series of processes, and, for example, it is only needed that the following operation of the instruction can be realized for this interval.

The processing circuit 10 can also acquire the first data structure (first tree) as an initial value, for example, via the input and output I/F 14. When the data in the first data structure is acquired via the input and output I/F 14, the processing circuit 10 may store the data in the storage circuit 12.

When receiving data in a graph representation indicating, for example, a variable as a node and indicating a process as an edge, as data indicating the series of processes including the plurality of instructions, the processing circuit 10 represents the data in the graph representation using a time-series data structure. This time-series data is, for example, a representation of a plurality of instructions arranged in a time-series order. Besides, the data in the graph representation may be data in which the node represents the process. In any case, at least the amount of memory to be used by a variable being an input/output of the process is acquired.

The first data structure can be described, for example, as the first tree using a segment tree. By describing the first data structure using the segment tree, the processing circuit 10 can change the amount of memory at each time point using less time and cost for each input/output variable of the instruction when executing the manipulation such as a swap of the processes or the like. Further, by describing the first data structure using the segment tree, the processing circuit 10 can find an evaluation value of the whole program with less time and cost. The evaluation value can be acquired from the maximum value of the amount of memory, the total of the amounts of memory at each time point, the total of the process execution times, an approximate value of them, or the like. Further, the user can easily implement the change in amount of memory used.

Note that it is possible to use, as the evaluation value as the above non-limiting example, information indirectly representing the maximum value of the amount of memory, the total of the amounts of memory at each time point, the total of the process execution times, an approximate value of them, or the like, information correlated with these values, or an arbitrary combination of the information pieces exemplified as examples.

Further, the representation of data indicating the memory used is not limited to the segment tree, but may be the one presenting it by other data structures such as a square root decomposition or a balanced binary tree (for example, a red-black tree), in which change and value calculation for the interval are supported. Note that the calculated value may be the one which can be acquired for each interval or the one which can be acquired for the whole of the series of processes.

The data structure holds a column of values. When the length of the column is n, n is at least equal to or more than the number of instructions included in the series of processes. A k-th value from the front along the time series stores information such as the instruction and the amount of memory at time k. Note that the data structure may hold information other than the amount of memory, or the value to be held does not need to be a real value but may be in a form of holding a quantity of a vector, a tensor, a complex number, or the like.

In the data structure, a change with respect to the interval is supported as follows. For example, when adding or deleting an instruction at a certain time point, there will be a need for the data structure to store the value of the variable relating to the instruction on the memory from a certain time point to another certain time point. In this case, the processing circuit 10 executes an update of adding or subtracting the value of the variable for the memory size, for an interval corresponding to the time points of the data structure.

Further, in the data structure, the value calculation for a predetermined interval (one or a plurality of intervals) is supported as follows. For example, in the case where the predetermined interval is the entire column of values of the time series, the processing circuit 10 finds the maximum value of the column of the values in the data structure, and thereby can find the maximum amount of memory required in the series of processes, namely, the amount of memory required for executing the whole program representing the series of processes.

The examples for finding the amount of memory are the update of addition or subtraction in the interval and the value calculation of the maximum value in the interval in the above, but the present invention is not limited to these. For example, the processing circuit 10 refers to the column in the data structure and thereby can acquire the execution time as the calculated value. As the other example, the processing circuit 10 refers to the column in the data structure and thereby can acquire various values such as the total value of the amounts of memory relating to the series of processes in the interval and log sumexp for the interval.

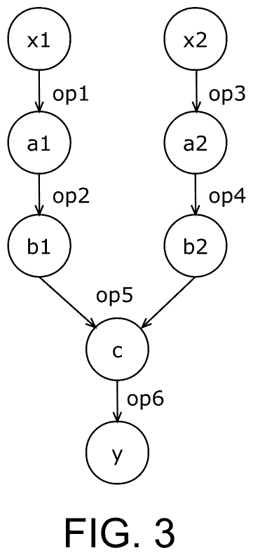

FIG. 3 is a chart illustrating the series of processes describing the variables according to an embodiment in a graph. The node represents a variable. The edge represents that the variable of a departure node is converted by an instruction at an arrival node. In the case where one node is connected to another node by one edge, the edge may be understood to represent the instruction, and passing through the edge means that the instruction indicated by the edge is applied to the variable.

On the other hand, the case where the edges from a plurality of nodes arrive as the node indicating c can indicate that an operation is executed by an instruction such as c=op5 (b1, b2) on variables b1, b2 which are the departure nodes of the plurality of edges to acquire c.

An instruction op1 is applied to a variable x1 to calculate a variable a1, and an instruction op2 is applied to the variable a1 to calculate the variable b1. Similarly, an instruction op3 is applied to a variable x2 to calculate a variable a2, and an instruction op4 is applied to the variable a2 to calculate the variable b2. Then, an instruction op5 is applied to the variables b1, b2 to calculate the variable c, and an instruction op6 is applied to the variable c to calculate an output y.

Further, for example, there is also a case where only at least either op5_1 (b1) or op5_2 (b2) is required to find c. Further, there is also a case having a branch for a conversion result of b1 and a conversion result of b2 in order to acquire c. In these cases, the series of processes can be appropriately described using the first data structure.

Even an expression of (output variable set)=op (input variable set) as a more general expression can be appropriately expressed as the first data structure.

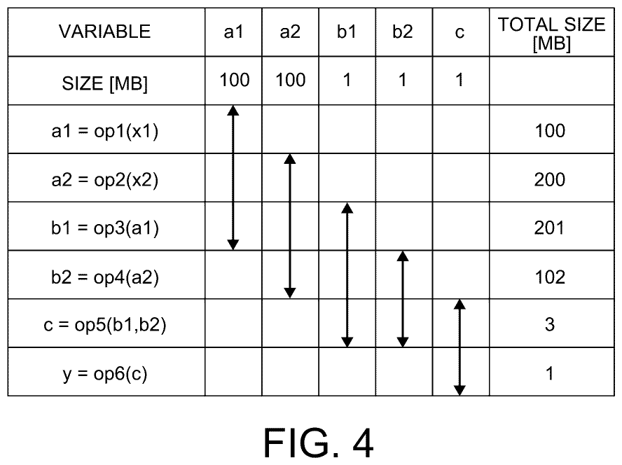

FIG. 4 is a chart illustrating an example of the time-series variation in amount of memory used in the processes in FIG. 3. The uppermost row indicates variables, and each variable uses the amount of memory at the second row. An arrow indicates the lifetime of each variable. The processing circuit 10 can set the time-series interval based on the lifetime of each variable.

A size [MB] is a size required at timing when using the variable. The timing when using the variable is, for example, a concept including timing of storing the variable for use in another instruction so that the variable is used in the later instruction, also during execution of the instruction not using the variable.

Besides, a total size [MB] is an amount of memory required at timing when executing an instruction indicated on the left in the table. The content indicated by the total size is, for example, a concept including an amount of memory required at timing when executing the instruction op2, an amount of memory required at a time point when executing the instruction op2, or an amount of memory for storing the variable explained in the above size in the interval when executing the instruction op2.

The lifetime of the variable is set, for example, based on timing when each instruction forming the series of processes finds the variable as an output, timing when each instruction requires the variable as an input, or the like. For example, a variable a1 (100 [MB]) is held on the memory from the timing when the instruction op1 is started to the timing when the instruction op3 is completed, and a variable a2 (100 [MB]) is held on the memory from the timing when the instruction op2 is started to the timing when the instruction op4 is completed. Therefore, at the timing when executing the instruction op2, both the variables a1, a2 are held on the memory, and the total size of the amounts of memory used is 200 [MB].

The processing circuit 10 computes a total value of the variable, instruction, and the memory for use, in a manner to basically trace the nodes in order from the variable indicated at the node at the end of the processing flow described in time series. The processing circuit 10 generates the first data structure (for example, the first tree) using the amount of memory used of each variable and the total size of the amounts of memory used, as the first amount of memory, for example, for each time-series interval in which one instruction is continued.

By describing in the above data structure (for example, the tree), even in the case of manipulating the order or the like of the instructions in the series of processes, the processing circuit 10 can easily acquire the amount of memory of each variable and the total memory amount in the period when each instruction is executed. The processing circuit 10 can easily acquire the total memory amount in consideration of the amount of memory for holding, for example, the variable required not for use in the instruction op2 but for use in the next instruction op3.

Returning to FIG. 2, after generation of the structure data indicating the memory usage, the processing circuit 10 executes the manipulation of the instruction or the variable corresponding to the structure data (S20). This manipulation may include, for example, at least any of the addition of an instruction, the swap of instructions, the deletion of an instruction, the movement of an instruction, the manipulation of the storage place for the variable, and the manipulation on the variable. Further, the manipulation may be a combination of a plurality of manipulations. The manipulation will be explained in detail later.

The processing circuit 10 computes a new amount of memory used (second amount of memory) reflecting the manipulated instruction to generate a second data structure (second tree) (S30). The generation of the second data structure may be the same as at S10 above, and the processing circuit 10 computes a second amount of memory being an amount of memory used, for each time-series interval for the process after the manipulation, and generates the second data structure as a set for each computed time-series interval. Further, the processing circuit 10 can also manipulate at least a part of the first data structure at S20 above to acquire an updated result as the second data structure.

The processing circuit 10 computes an evaluation value based on at least the second amount of memory on the basis of the second data structure, and updates the series of processes in consideration of the first data structure, the order of the instructions corresponding to the first data structure, and so on according to this evaluation value (S40). The processing circuit 10 determines whether to update the first data structure by, for example, determining whether a condition (first condition) of comparing the evaluation value and a predetermined threshold is satisfied.

The processing circuit 10, when determining to update, updates the current second data structure as the first data structure to be used in the operation in the next iteration. The processing circuit 10, when determining not to update, uses the current first data structure as the first data structure to be used in the operation in the next iteration. The processes of the evaluation and update will be explained in detail later.

The processing circuit 10 determines whether the optimization has been completed after the update/non-update of the first data structure and the corresponding instruction (S50). As the completion condition of the optimization (second condition), an arbitrary condition can be set. The completion condition can be, for example, that manipulation, evaluation, and update have been repeated a predetermined number of times, a condition relating to a predetermined parameter that the predetermined parameter becomes smaller than a predetermined value, that a predetermined time has elapsed, that update has not been executed during a predetermined times of optimization loop or during a predetermined time, or a combined condition of them.

When the optimization has not been completed (S50: NO), the processing circuit 10 repeats the processes from S20 to S40.

When the optimization is completed (S50: YES), the processing circuit 10 converts the optimized processing flow into an arbitrary format, for example, a graph format, and outputs it (S60). Note that the output includes the process of storing the result into the storage circuit 12 in addition to the output to the outside via the input and output I/F 14. Further, the processing circuit 10 may output the amount of memory used, in particular, the maximum value of the amount of memory used in addition to the processing flow.

Next, the processes of the optimization process (S20, S40) will be explained in detail. These processes can be suppressed in calculation cost by using the tree representation, for example, the representation of the segment tree, and can be improved in accuracy of the optimization and the reduction in optimization time as a result.

The update/non-update can be determined, for example, based on Monte Carlo simulation. In addition to this, the processing circuit 10 can apply, for example, another meta-heuristics optimization method such as a genetic algorithm. An example using an annealing method will be explained as an example, but the implementation of the optimization method is not limited to this example.

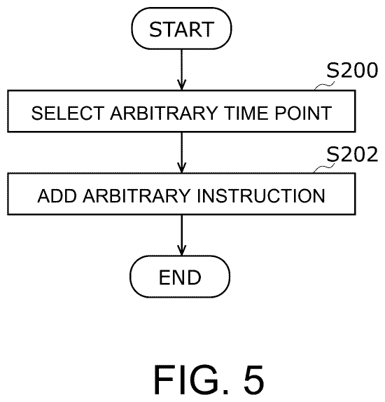

FIG. 5 is a flowchart illustrating an example of the manipulation of the processes according to an embodiment. The processing circuit 10 selects an arbitrary time point in the time series of the plurality of instructions corresponding to the first tree (S200). The arbitrary time point may be a time point between instructions. The processing circuit 10 selects, for example, a random time point in the example in FIG. 4, resulting in that a time point between the instruction op1 and the instruction op2 is selected.

The processing circuit 10 performs a manipulation of additionally inserting an arbitrary instruction at the selected arbitrary time point (S202). The instruction to be added may be nop or another arbitrary instruction which does not change the operation result. In the above example, the processing circuit 10 additionally inserts an arbitrary process between the instruction op1 and the instruction op2.

Note that the arbitrary instruction described here can be an arbitrary instruction in a situation where the result of the series of processes does not change. The processing circuit 10 can confirm, for example, the dependency relationship or the like of the variable such that the variable to be used in the arbitrary instruction has been already calculated before the arbitrary instruction at the arbitrary time point is added, and can add an actual instruction when there is no problem in the dependency relationship or the like.

The processing circuit 10 may randomly select a time point and additionally insert the randomly selected instruction as an example. The processing circuit 10 can also select a time point based on a predetermined rule at S200. Further, the processing circuit 10 can also select an instruction to be additionally inserted based on the predetermined rule at S202.

The predetermined rule relating to the selection of the time point may be, for example, the one that depends on the time relating to the memory for increasing or decreasing the probability of selecting the period when there is no margin in the memory or the period when there is a margin in the memory. Further, as the predetermined rule relating to the instruction to be additionally inserted, such a rule can be set that an instruction using a small memory usage for input and a large memory usage for output.

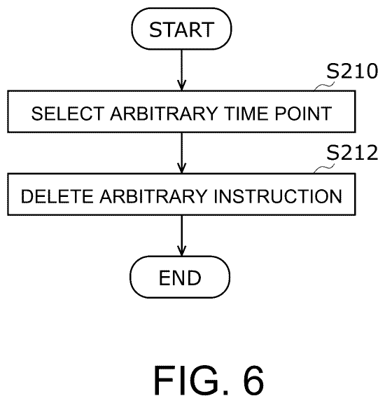

FIG. 6 is a flowchart illustrating an example of the manipulations of the instructions according to an embodiment. The processing circuit 10 selects an arbitrary time point in the time series of the plurality of instructions corresponding to the first tree (S210). This arbitrary time point may be a time point during execution of some kind of instruction. The processing circuit 10 selects, for example, a random time point or a time point based on a predetermined rule in the example in FIG. 4, resulting in that the processing time point of the instruction op3 is selected and the instruction op3 is selected.

The processing circuit 10 performs a manipulation of deleting the selected instruction (S212). The processing circuit 10 deletes the instruction which does not change the operation result. In the above example, the processing circuit 10 deletes the instruction op3.

For example, when trying to delete the instruction to output a variable x at a time point t, the processing circuit 10 determines whether there is an instruction using the variable x after the time point t. If the instruction using the variable x exists after the time point t in this determination, the processing circuit 10 confirms whether the variable x has been output before the instruction using the variable x. If it cannot be confirmed that the variable x has been appropriately output, the processing circuit 10 avoids the deletion of the instruction to output the variable x at the time point t.

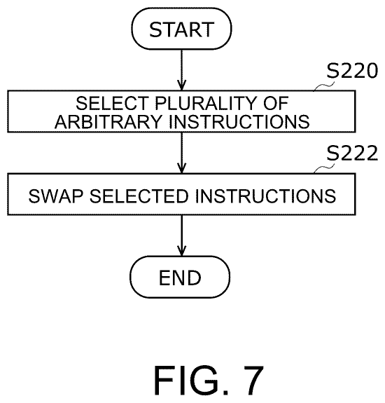

FIG. 7 is a flowchart illustrating an example of the manipulation of the instruction according to an embodiment. By combining FIG. 5 and FIG. 6, the processing circuit 10 can perform, for example, a manipulation of moving the arbitrarily selected instruction at an arbitrarily selected time point. In other words, the processing circuit 10 can swap the order of two or more arbitrarily selected instructions.

In the case of swapping the order of the instructions, the processing circuit 10 acquires the dependency relationship of the variables as has been explained in the manipulations, and performs a swap manipulation in a range in which the operation result does not change even if the instructions are swapped, based on the dependency relationship of the variables.

In summary, the processing circuit 10 selects a plurality of arbitrary instructions as in the flow of the flowchart (S220). The processing circuit 10 selects the instructions op2, op3 as a result of selecting the plurality of instructions, for example, randomly or based on the predetermined rule.

Then, the processing circuit 10 swaps the selected instructions in the range in which the operation result does not change (S222). The processing circuit 10 swaps, for example, the order of the selected instructions op2, op3. As a result of this, the processing circuit 10 can perform a so-called swap manipulation on the instruction op2 and the instruction op3 as an example.

This manipulation can be rephrased as a manipulation of selecting the instruction op3 as an arbitrary instruction (instruction at a random time point or at a time point selected based on the predetermined rule), selecting a time point between the instructions op1 and op2 as the arbitrary time point (another random time point or a time point selected based on another predetermined rule), and inserting the selected op3 at the selected time point.

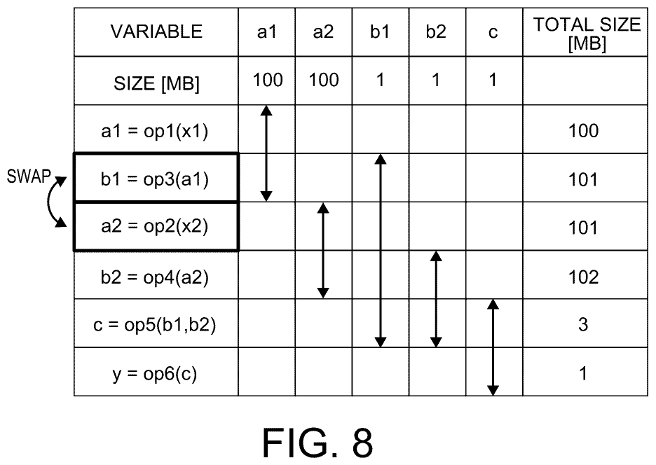

FIG. 8 is a chart illustrating an example of the time-series variation in amount of memory used according to an embodiment. The processing circuit 10 generates the second tree representing the amount of memory used as a set for each time-series interval for the instruction after the manipulation according to FIG. 8. For example, as the process at S30 in FIG. 2, the processing circuit 10 computes a total amount of memory used by rearranging the memory used for each time-series interval, and generates the second memory using the amount of memory rearranged and the total memory amount as the second amount of memory.

It can be found that the amount of memory occupied by the series of processes including the plurality of instructions can be suppressed by manipulating the instruction from the state in FIG. 4 to the state in FIG. 8. As explained above, by executing the above manipulation, the memory occupancy as a whole of the series of processes may be reduced.

Note that this swap manipulation is not limited to swap, but can be the manipulation of instructions of rotate and shuffle by selecting three or more instructions. The rotate is a manipulation of shifting the plurality of instructions in a manner not to disrupt their circular order. For example, the manipulation of moving the instruction op2 to between the instruction op4 and the instruction op5 in FIG. 4 can be rephrased as the process of rotate of the instructions op2, op3, op4. The shuffle is a swap manipulation among a plurality of instructions, and is a manipulation including rotate as a matter of course.

As explained above, the processing circuit 10 can perform the manipulation of arbitrarily selecting an arbitrary number of instructions and arbitrarily swapping them as the manipulation of the instruction.

The manipulation of the instruction executed by the processing circuit 10 is not limited to the above. The processing circuit 10 can perform the manipulation of not only the instruction but also deletion of a variable from the memory and the like. By allowing a deletion manipulation of the variable on the memory, the processing circuit 10 can perform, for example, the manipulation relating to the recalculation of the variable.

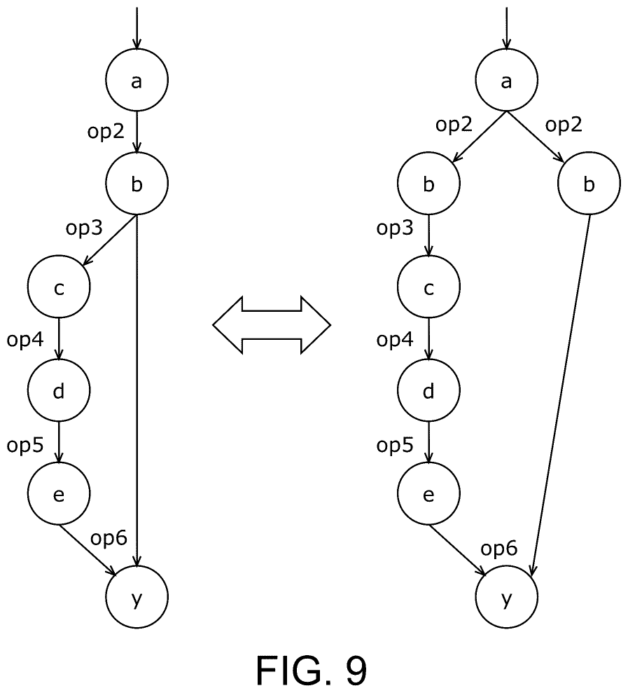

FIG. 9 is a chart illustrating an example of deleting the variable on the memory and recalculating, or deleting calculation and holding the variable on the memory for a long time. For example, it is assumed that variables b, e are required to calculate y, and the variable b is a variable required in a stage of calculating the variable e.

As means for reducing the operation, the process is executed in a flow of increasing the lifetime of the variable b on the memory and eliminating the recalculation of the variable b (left chart). The operation amount can be reduced, whereas the variable b occupies the area on the memory for a long time.

As means for reducing the memory usage, the process is executed in a flow of decreasing the lifetime of the variable b on the memory and recalculating the variable b (right chart). The memory usage can be reduced as a whole, whereas the variable b needs to be recalculated.

One of the flows can be selected based on the operation cost required to calculate the variable b and the memory area required to store the variable b. The processing circuit 10 can execute the optimization corresponding also to the change in order of the instructions and the deletion of the variable on the memory as above.

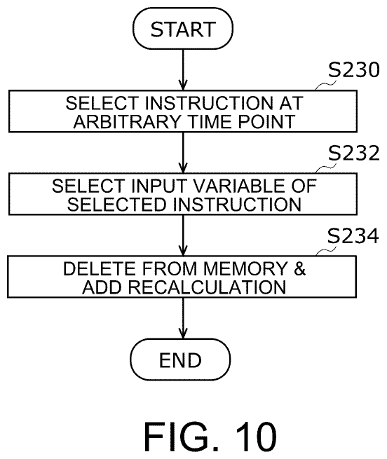

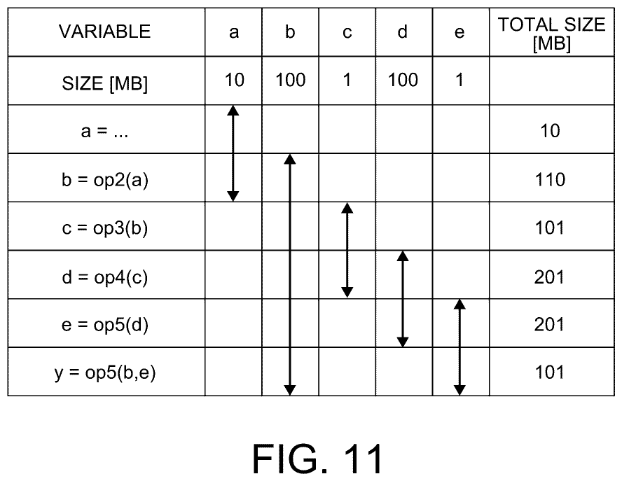

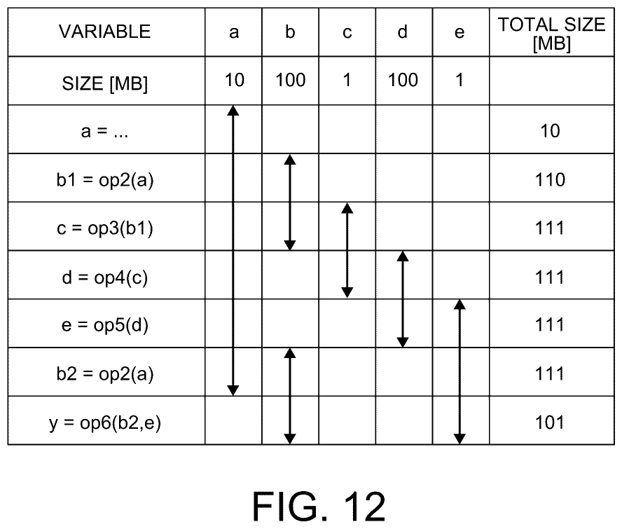

FIG. 10 is a flowchart illustrating an example of the manipulation of the instruction according to an embodiment. Besides, FIG. 11 is a chart illustrating an example of the time-series variation in amount of memory used according to an embodiment. Note that FIG. 11 and FIG. 12 each illustrate a series of processes different from that in FIG. 4 and so on, and have no particular relevance in the order of processes, the amount of memory, and so on.

The processing circuit 10 selects an instruction at an arbitrary time point (instruction at a random time point or a time point selected based on a predetermined rule) (S230). The processing circuit 10 selects, for example, an instruction op6 in the left chart in FIG. 9.

The processing circuit 10 selects a random variable from input variables of the selected instruction op6 (S232). The processing circuit 10 selects, for example, the variable b from the input variables of the instruction op6 (S232).

When determining that the variable b can be temporarily deleted from the memory and recalculated, the processing circuit 10 performs a manipulation of temporarily deleting this variable b from the memory and adding an instruction to recalculate it (S234).

As can be seen in FIG. 11, the variable b, after being used in the instruction op3, is not used until the instruction op5. Therefore, the processing circuit 10 performs a manipulation of releasing the memory area for the variable b after the instruction op3 and adding an instruction to recalculate the variable b at some timing until the instruction op5.

FIG. 12 is a chart illustrating an example of the time-series variation in amount of memory used according to an embodiment. The processing circuit 10 can add the instruction to recalculate the variable b before the instruction op5, desirably, immediately before the process op5 for which the variable b is required, to make the state in FIG. 12.

For explanation, the variable b is regarded as separate variables b1, b2 depending on the time point. After the variable c=op3 (b1) is found in the instruction op3, the processing circuit 10 releases the memory relating to the variable b1. The processing circuit 10 then finds b2=op2(a) before the timing when finding y, and thereby reacquires the variable b2 as the variable b, and calculates the variable y as y=op6(b2, e).

By the manipulation from the state in FIG. 11 to the state in FIG. 12, the memory occupancy as a whole of the series of processes may be reduced. As explained above, in the case where one instruction is arbitrarily selected from a plurality of instructions corresponding to the first tree and, for at least one of input variables of the instruction, the input variable is used in an instruction previous thereto, the processing circuit 10 can perform a manipulation of deleting the variable from the memory after completion of the previous instruction and adding an instruction to recalculate it before, for example, immediately before the selected instruction.

The processing circuit 10 can also execute the above process in the case of not selecting the instruction at an arbitrary time point but selecting an arbitrary variable and determining that this variable is input into a plurality of instructions.

Conversely, in the case where the influence of the operation amount of the variable b is larger than the influence of the memory usage of the variable b, it is desirable to be able to perform the manipulation of the instruction from the right chart to the left chart in FIG. 9.

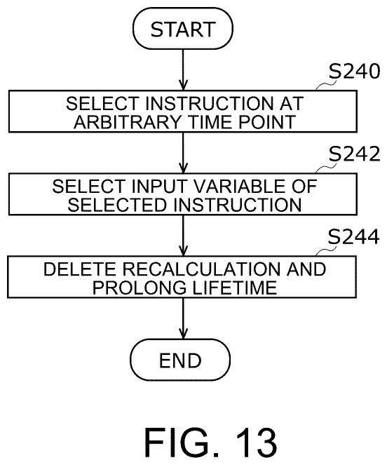

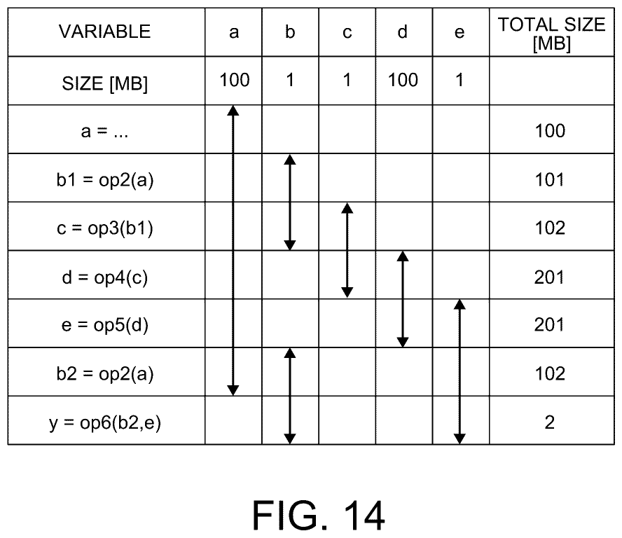

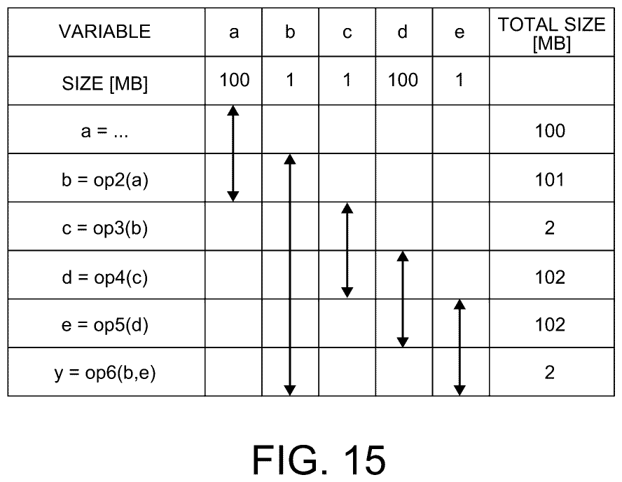

FIG. 13 is a flowchart illustrating an example of the manipulations of the instructions according to an embodiment. FIG. 14 and FIG. 15 are charts illustrating an example of the time-series variation in amount of memory used before and after the manipulation. Note that FIG. 14 and FIG. 15 illustrate a series of processes different from those in FIG. 4, FIG. 11, and so on as above, and have no particular relevance in the order of processes, the amount of memory, and so on.

The processing circuit 10 selects an instruction at an arbitrary time point (instruction at a random time point or a time point selected based on a predetermined rule) (S240). The processing circuit 10 selects, for example, an instruction op6 as a result of arbitrary selection in the right chart in FIG. 9.

The processing circuit 10 selects an arbitrary variable from input variables of the selected instruction op6 (S242). The processing circuit 10 selects, for example, a variable b from the input variables of the instruction op6 as a result of selection randomly or based on a predetermined rule.

When determining that the variable b2 being the recalculation of the variable b can be deleted and the lifetime of the variable b1 as the previous operation result on the memory can be prolonged, the processing circuit 10 performs a manipulation of deleting the recalculation process and prolonging the lifetime of the variable b1 which has been previously acquired (S244).

As can be seen in FIG. 14, the variable b1 is calculated in the instruction op2 immediately before the instruction op3, then deleted once from the memory, and recalculated as the variable b2 in the instruction op2 immediately before the instruction op6. Therefore, the processing circuit 10 performs a manipulation of deleting the instruction op2 immediately before the instruction op6 and holding the already-calculated variable b1 on the memory also after the instruction op3.

As a result of this, as illustrated in FIG. 15, the lifetime of the variable b is prolonged, and it becomes possible to perform a manipulation of bringing the state into a state of deleting the recalculation process of the variable b.

By the manipulation from the state in FIG. 14 to the state in FIG. 15, the memory occupancy as a whole of the series of processes may be reduced. As explained above, in the case where one instruction is arbitrarily selected from a plurality of instructions corresponding to the first tree and, for at least one of input variables of the instruction, the input variable is used in an instruction previous thereto is used, the processing circuit 10 can perform a manipulation of holding the variable on the memory also after completion of the previous instruction and deleting the recalculation process before, for example, immediately before the selected instruction.

The processing circuit 10 does not select the instruction at an arbitrary time point but selects an arbitrary variable and determines whether there is a recalculation for the selected variable, and can also perform a manipulation such as deletion of the recalculation or the like

As explained above, the processing circuit 10 can add the recalculation or delete the recalculation as a manipulation of the instruction.

Besides, in the example from FIG. 10 to FIG. 15, the manipulation of adding and deleting the recalculation is illustrated, but the manipulation on the variable is not limited to this. For example, the processing circuit 10 can also perform a manipulation of adding and deleting the process of upload and/or download of a variable such as transferring a variable held in a memory area (first memory) relatively high in access speed to a memory area (second memory) lower in access speed compared to that, or conversely transferring the variable from the memory area of the second memory lower in access speed to the memory area of the first memory higher in access speed.

As a non-limiting example, the first memory may be a shared memory, a cache, or the like, and the second memory may be a memory such as an external memory, a storage, or the like.

As a non-limiting concrete example, the processing circuit 10 can perform a manipulation of adding and deleting an instruction to transfer the variable on a shared memory in CUDA (registered trademark) to a global memory and/or an instruction to transfer a variable on the global memory to the shared memory.

Returning to FIG. 2, the processing circuit 10 generates the second tree corresponding to the instruction after manipulation in the manipulation (FIG. 5, FIG. 6, FIG. 10, FIG. 13, or the like) at S30. Then, the processing circuit 10 executes evaluation based on the second tree and update of the first tree based on the evaluation at S40.

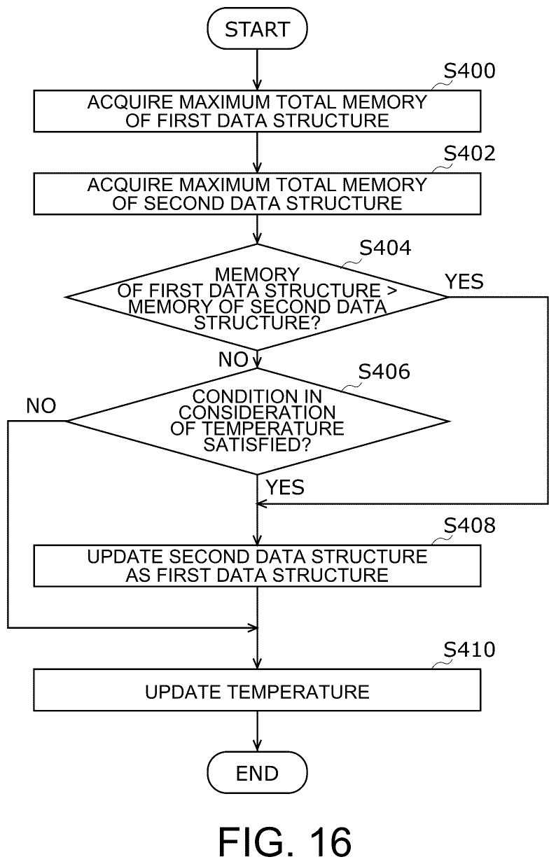

FIG. 16 is a flowchart illustrating a non-limiting example of the process of evaluation and update (S40 in FIG. 2) according to an embodiment. This evaluation and update process may be implemented by a method based on Monte Carlo simulation, for example, an annealing method.

The processing circuit 10 extracts the maximum value of the total memory amount of the first data structure (first tree) (S400).

The processing circuit 10 extracts the maximum value of the total memory amount of the second data structure (second tree) (S402).

The processing circuit 10 compares the total memory maximum of the first data structure (the same value as the maximum value of the first amount of memory) and the total memory maximum of the second data structure (the same value as the maximum value of the second amount of memory) (S404).

When the total memory maximum of the first data structure is equal to or less than the total memory maximum of the second data structure (S404: NO), the processing circuit 10 determines whether the condition in consideration of the temperature is satisfied (S406). The temperature is a temperature parameter in the case of using the annealing method as the optimization method as a non-limiting example.

The processing circuit 10 accepts the determination at a probability, for example, based on the temperature (for example, a probability obtained by dividing, by the temperature, a result obtained by subtracting the total memory maximum of the second data structure from the total memory maximum of the first data structure, and exponentiating Napier's constant by the result) and determines that the update condition is satisfied (S406: YES).

When it is determined that the update condition is satisfied (S404; YES or S406: YES), the processing circuit 10 updates the first data structure so that the second data structure can be used as the first data structure in the next iteration (S408). Accompanying this, the lifetime on the memory of the instruction and/or variable changed by the manipulation at S20 is also updated.

When it is determined that the update condition is not satisfied (S404; NO and S406: NO), the processing circuit 10 does not update the current first data structure and uses it as the first data structure in the next iteration.

Thereafter, the processing circuit 10 updates the temperature, for example, updates the temperature according to the number of times of iteration (S410), and then shifts to the process at S50 in FIG. 2.

The flowchart in FIG. 16 is illustrated as an example, and can be optimized using another meta-heuristics algorithm.

Generally, in the case of executing the manipulations of swapping the instructions and changing the lifetime of the variable on the memory, a considerable time is required to extract the maximum value of the total amount of memory of the manipulations and thereafter. On the other hand, by using the segment tree illustrated as the non-limiting example in this disclosure, it is possible to set the time for swapping the instructions and the time for extracting the maximum value of the amount of memory to O(log N) with the length of the manipulation column as N. Therefore, by generating the tree based on the amount of memory, it is possible to reduce the extraction processing time for the maximum value in the optimization while ensuring the match of the treatment results.

### MODIFICATION EXAMPLES

The optimization is executed based only on the maximum amount of the memory for use in the above, but is not limited to this.

For example, as the evaluation at S40 in FIG. 2, an approximate processing time as a whole of the series of processes can be used as an index.

The processing circuit 10 can perform update and determination using, for example, the amount of memory and the processing time as separate indexes using separate evaluation criteria.

The processing circuit 10 can perform update and determination using, for example, an evaluation value including (amount of memory)×(processing time).

The processing circuit 10 can perform update and determination using, for example, an evaluation value including (amount of memory)×(processing time)².

Specifically, it is possible to use, as the objective function, an arbitrary evaluation value expressed in a form including at least one of the processing time and the amount of memory used.

As another example, the processing circuit 10 may use, as an index, not only the maximum amount of memory but also the second largest amount of memory, the third largest amount of memory, or the like. In this case, it is also to make the evaluation using an average equivalent amount of memory or using an index (for example, dispersion or the like) in which the amount of memory used is suppressed on average though locally large.

A processor executing the series of processes (another processor different from the processing circuit 10) may be a processor having, for example, a plurality of arithmetic cores and a shared memory accessible from the plurality of arithmetic cores faster than the memory area outside the processor. As a representative example, the processor can include at least a GPU or a multicore CPU.

Further, the annealing method, as a non-limiting example, is exemplified as the optimization method in each of the above embodiments, and the optimization method to be used can be a method high in speed and high in accuracy. The information processing device 1 can also use a convergence method such as the Replica Exchange Method based on another random walk or the Monte Carlo method, for example, as the optimization method. It is also possible to adopt the machine learning technique such as reinforcement learning, or adopt the method such as the Las Vegas method which can surely acquire a solution.

In this disclosure, the information processing device can be understood to be an information processing device including a processor which executes an optimized program, an information processing device including a processor which optimizes a program, or an information processing device including a processor which executes both the operations.

Further, the processor of the information processing device does not need to be installed in one housing and can also execute the optimization of the above program by a plurality of processors connected over a network or the like in cooperation, execute the optimized program, or execute both of them.

Further, at least one of the above information processing devices may have a processor which can convert the intermediate language generated by the information processing method according to each of the above embodiments into a format of an execution file (machine language) suitable for the information processing device, which executes the program by linker or the like, to execute. Further, at least one of the above information processing devices may have a processor which executes the process relating to the execution file (machine language).

This intermediate language or execution file can be generated based on the data structure updated by the method described in any of the above embodiments. In other words, the information processing device can also generate these intermediate language, execution file, or the like as a final product, based on the data structure updated by the method described in any of the above embodiments.

Some or all of each device (the information processing device) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

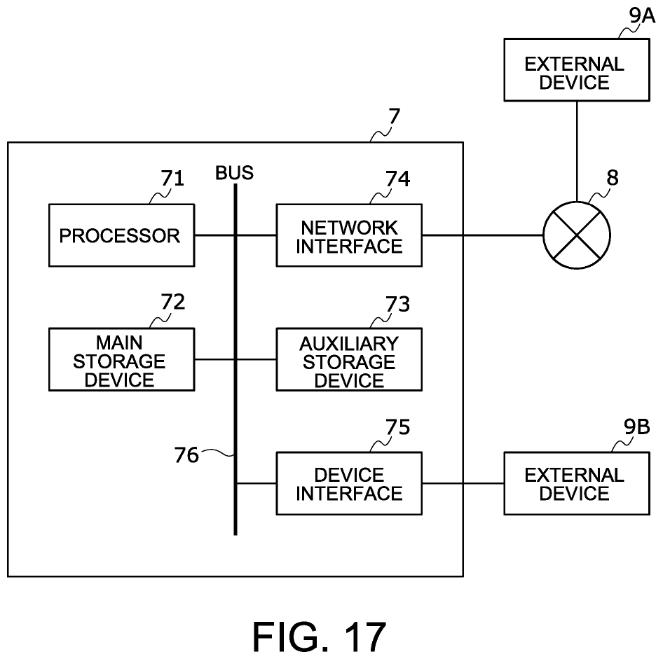

FIG. 17 is a block diagram illustrating an example of a hardware configuration of each device (the information processing device) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 17 is provided with each component one by one but may be provided with a plurality of the same components. Although one computer 7 is illustrated in FIG. 17, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (the information processing device) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (the information processing device) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuitry, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (the information processing device) in the above embodiments may be enabled by one or more processors 71. The processor 71 may refer to one or more electronic circuits located on one chip, or one or more electronic circuitries arranged on two or more chips or devices. In the case of a plurality of electronic circuitries is used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (the information processing device) in the above embodiments may be enabled by the main storage device 72 or the auxiliary storage device 73 or may be implemented by a built-in memory built into the processor 71. For example, the storages 12 in the above embodiments may be implemented in the main storage device 72 or the auxiliary storage device 73.

In the case of each device (the information processing device) in the above embodiments is configured by at least one storage device (memory) and at least one processor connected/coupled to/with this at least one storage device, the at least processor may be connected to a single storage device. Or the at least storage may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (the information processing device) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrical connection/coupling,” “communicative connection/coupling,” “operative connection/coupling,” “physical connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize/minimization” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize/optimization” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

Above embodiments can be summarized as follows:

(1) An information processing device comprising:
at least one memory; and
at least one processor configured to:
   acquire a first data structure including information on an execution order of a plurality of instructions and information on an amount of memory required for execution of each instruction;
   generate a second data structure in which the information on the execution order and the information on the amount of memory are updated, by executing a manipulation on the first data structure;
   acquire an evaluation value based on the second data structure; and
   update the first data structure using the second data structure in a case where the evaluation value satisfies a first condition, wherein:
the first data structure and the second data structure are data structures in which change and value calculation for a predetermined interval are supported; and
the at least one processor executes, a plurality of times, the generation of the second data structure, the acquisition of the evaluation value, or the update of the first data structure when the evaluation value satisfies the first condition.

“Updating the first data structure using the second data structure” as described above includes not only the process of overwriting the first data structure with the second data structure, but also the case where the second data structure is used as the first data structure in subsequent repeated processes.

Furthermore, “executing multiple times” may include repeated execution. Repeated execution may include execution using a loop (iteration).

(2) The information processing device according to (1), wherein the first data structure and the second data structure acquire a total amount of memory required at timing when executing each instruction, as the information on the amount of memory.

The total amount of memory may not only be an exact total memory amount, but also an approximate value of the total amount of the memory.

(3) The information processing device according to (1) or (2), wherein the first data structure and the second data structure are at least any of a segment tree, a square root decomposition, or a balanced binary tree.

(4) The information processing device according to any one of (1) to (3), wherein the manipulation includes at least one of:
a manipulation of adding a selected instruction at a selected time point;
a manipulation of deleting an instruction at a selected time point;
a manipulation of moving an instruction at a selected time point to another selected time point;
a manipulation of storing, when at least one variable to be used for an instruction at a selected time point is stored in a first memory, the at least one variable in a second memory lower in access speed than the first memory, and storing, when the at least one variable is stored in the second memory, the at least one variable in the first memory;
a manipulation of deleting at least one variable stored in the first memory at a selected time point from the first memory, and adding an instruction to recalculate the at least one variable before an instruction in which the at least one variable is used; or
a manipulation of deleting an instruction to recalculate at least one variable stored in the first memory at a selected time point, and storing the at least one variable in the first memory at least until an instruction in which the variable is used.

(5) The information processing device according to (4), wherein the selected time point is a randomly selected time point.

(6) The information processing device according to (4), wherein the selected instruction is a randomly selected instruction.

(7) The information processing device according to any one of (1) to (6), wherein the manipulation executed on the first data structure is randomly selected from among a plurality of manipulations.

(8) The information processing device according to any one of (1) to (7), wherein the evaluation value is a value computed by value calculation for a predetermined interval of the second data structure.

(9) The information processing device according to any one of (1) to (8), wherein the evaluation value is a value based on an amount of memory required in each instruction of the second data structure.

(10) The information processing device according to (9), wherein the evaluation value is a maximum value of an amount of memory required in each instruction of the second data structure.

(11) The information processing device according to any one of (1) to (10), wherein the first condition is a condition relating to at least any one of an amount of memory or a processing time.

(12) The information processing device according to (11), wherein the first condition is that a maximum value of an amount of memory required in each instruction of the second data structure becomes smaller than a maximum value of an amount of memory required in each instruction of the first data structure.

The above configuration is a concept that also includes a case where the conditional expression is used to determine whether the maximum amount of the memory required for the each process of the second data structure is less than or equal to the maximum amount of the memory required for the each process of the first data structure.

(13) The information processing device according to any one of (1) to (12), wherein the evaluation value is a value based on an operation cost required for execution of a plurality of instructions of the second data structure and an amount of memory required in each instruction of the second data structure.

(14) The information processing device according to any one of (1) to (13), wherein the at least one processor repeatedly executes, until a second condition is satisfied, the generation of the second data structure, the acquisition of the evaluation value, and the update of the first data structure when the evaluation value satisfies the first condition.

(15) The information processing device according to (14), wherein the second condition is at least one of that the repeated execution has been executed a predetermined number of times or more, a condition relating to a predetermined parameter, that a predetermined time has elapsed, that the update process has not been executed during a repeated execution a predetermined number of times, or that the update process has not been executed for a predetermined time.

(16) The information processing device according to any one of (1) to (15), wherein the at least one processor generates the first data structure from a plurality of instructions described in a graph.

(17) The information processing device according to any one of (1) to (16), wherein the at least one processor generates an intermediate language using the first data structure for which the manipulation has been executed a plurality of times.

(18) The information processing device according to any one of (1) to (16), wherein the at least one processor generates a machine language using the first data structure for which the manipulation has been executed a plurality of times.

(19) A method for generating an intermediate language comprising generating the intermediate language by using the information processing device according to (17).

(20) A method for generating a machine language comprising generating the machine language by using the information processing device according to (18).

(21) A data structure generation method for generating a data structure using an information processing device according to any one of (1) to (18).

(22) An information processing method comprising:
acquiring, by at least one processor, a first data structure including information on an execution order of a plurality of instructions and information on an amount of memory required for execution of each instruction;
   generating, by the at least one processor, a second data structure in which the information on the execution order and the information on the amount of memory are updated, by executing a manipulation on the first data structure;
   acquiring, by the at least one processor, an evaluation value based on the second data structure; and
   updating, by the at least one processor, the first data structure using the second data structure in a case where the evaluation value satisfies a first condition, wherein:
the first data structure and the second data structure are data structures in which change and value calculation for a predetermined interval are supported; and
the at least one processor executes, a plurality of times, the generation of the second data structure, the acquisition of the evaluation value, and the update of the first data structure when the evaluation value satisfies the first condition.

Furthermore, the information processing method may further include a method having the features of any of the devices or methods described in any one of (2) to (21).

(23) A non-transitory computer-readable medium storing a program causing at least one processor to execute an information processing method,
the information processing method comprising:
   acquiring a first data structure including information on an execution order of a plurality of instructions and information on an amount of memory required for execution of each instruction;
   generating a second data structure in which the information on the execution order and the information on the amount of memory are updated, by executing a manipulation on the first data structure;
   acquiring an evaluation value based on the second data structure; and
   updating the first data structure using the second data structure in a case where the evaluation value satisfies a first condition, wherein:
the first data structure and the second data structure are data structures in which change and value calculation for a predetermined interval are supported; and
the at least one processor executes, a plurality of times, the generation of the second data structure, the acquisition of the evaluation value, and the update of the first data structure when the evaluation value satisfies the first condition.

Furthermore, the program may also be a program that specifically realizes, using hardware resources, information processing by software having the characteristics of any of the devices or methods described in any one of (2) to (21).

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing device comprising:
at least one memory; and
at least one processor configured to:
acquire a first data structure including information on an execution order of a plurality of instructions and information on an amount of memory required for execution of each instruction;
generate a second data structure in which the information on the execution order and the information on the amount of memory are updated, by executing a manipulation on the first data structure;
acquire an evaluation value based on the second data structure; and
update the first data structure using the second data structure in a case where the evaluation value satisfies a first condition, wherein:
the first data structure and the second data structure are data structures in which change and value calculation for a predetermined interval are supported; and
the at least one processor executes, a plurality of times, the generation of the second data structure, the acquisition of the evaluation value, and the update of the first data structure when the evaluation value satisfies the first condition.

2. The information processing device according to claim 1, wherein the first data structure and the second data structure acquire a total amount of memory required at timing when executing each instruction, as the information on the amount of memory.

3. The information processing device according to claim 1, wherein the first data structure and the second data structure are at least any of a segment tree, a square root decomposition, or a balanced binary tree.

4. The information processing device according to claim 1, wherein the manipulation includes at least one of:
a manipulation of adding a selected instruction at a selected time point;
a manipulation of deleting an instruction at a selected time point;
a manipulation of moving an instruction at a selected time point to another selected time point;
a manipulation of storing, when at least one variable to be used for an instruction at a selected time point is stored in a first memory, the at least one variable in a second memory lower in access speed than the first memory, and storing, when the at least one variable is stored in the second memory, the at least one variable in the first memory;
a manipulation of deleting at least one variable stored in the first memory at a selected time point from the first memory, and adding an instruction to recalculate the at least one variable before an instruction in which the at least one variable is used; or
a manipulation of deleting an instruction to recalculate at least one variable stored in the first memory at a selected time point, and storing the at least one variable in the first memory at least until an instruction in which the variable is used.

5. The information processing device according to claim 4, wherein the selected time point is a randomly selected time point.

6. The information processing device according to claim 4, wherein the selected instruction is a randomly selected instruction.

7. The information processing device according to claim 1, wherein the manipulation executed on the first data structure is randomly selected from among a plurality of manipulations.

8. The information processing device according to claim 1, wherein the evaluation value is a value computed by value calculation for a predetermined interval of the second data structure.

9. The information processing device according to claim 1, wherein the evaluation value is a value based on an amount of memory required in each instruction of the second data structure.

10. The information processing device according to claim 9, wherein the evaluation value is a maximum value of an amount of memory required in each instruction of the second data structure.

11. The information processing device according to claim 1, wherein the first condition is a condition relating to at least any one of an amount of memory or a processing time.

12. The information processing device according to claim 11, wherein the first condition is that a maximum value of an amount of memory required in each instruction of the second data structure becomes smaller than a maximum value of an amount of memory required in each instruction of the first data structure.

13. The information processing device according to claim 1, wherein the evaluation value is a value based on an operation cost required for execution of a plurality of instructions of the second data structure and an amount of memory required in each instruction of the second data structure.

14. The information processing device according to claim 1, wherein the at least one processor repeatedly executes, until a second condition is satisfied, the generation of the second data structure, the acquisition of the evaluation value, and the update of the first data structure when the evaluation value satisfies the first condition.

15. The information processing device according to claim 14, wherein the second condition is at least one of that the repeated execution has been executed a predetermined number of times or more, a condition relating to a predetermined parameter, that a predetermined time has elapsed, that the update process has not been executed during a repeated execution a predetermined number of times, that the update process has not been executed for a predetermined time, or a combined condition thereof.

16. The information processing device according to claim 1, wherein the at least one processor generates the first data structure from a plurality of instructions described in a graph.

17. The information processing device according to claim 1, wherein the at least one processor generates an intermediate language using the first data structure for which the manipulation has been executed a plurality of times.

18. The information processing device according to claim 1, wherein the at least one processor generates a machine language using the first data structure for which the manipulation has been executed a plurality of times.

19. An information processing method comprising:
acquiring, by at least one processor, a first data structure including information on an execution order of a plurality of instructions and information on an amount of memory required for execution of each instruction;
generating, by the at least one processor, a second data structure in which the information on the execution order and the information on the amount of memory are updated, by executing a manipulation on the first data structure;
acquiring, by the at least one processor, an evaluation value based on the second data structure; and
updating, by the at least one processor, the first data structure using the second data structure in a case where the evaluation value satisfies a first condition, wherein
the first data structure and the second data structure are data structures in which change and value calculation for a predetermined interval are supported; and
the at least one processor executes, a plurality of times, the generation of the second data structure, the acquisition of the evaluation value, and the update of the first data structure when the evaluation value satisfies the first condition.

20. A non-transitory computer-readable medium storing a program causing at least one processor to execute an information processing method,
the information processing method comprising:
acquiring a first data structure including information on an execution order of a plurality of instructions and information on an amount of memory required for execution of each instruction;
generating a second data structure in which the information on the execution order and the information on the amount of memory are updated, by executing a manipulation on the first data structure;
acquiring an evaluation value based on the second data structure; and
updating the first data structure using the second data structure in a case where the evaluation value satisfies a first condition, wherein:
the first data structure and the second data structure are data structures in which change and value calculation for a predetermined interval are supported; and
the at least one processor executes, a plurality of times, the generation of the second data structure, the acquisition of the evaluation value, and the update of the first data structure when the evaluation value satisfies the first condition.
